(19) United States
(12) Patent Application Publication
(10) Pub. No.: US 2002/0171418 A1
(43) Pub. Date: Nov. 21, 2002

(54) Arrangement for determining position, angle or rotational speed

(76) Inventors: Michael Hinz, Hamburg (DE); Stefan Pusch, Hamburg (DE); Michael Muth, Stelle (DE)

Correspondence Address: U.S. Philips Corporation, 580 White Plains Road, Tarrytown, NY, 10591, US

(21) Appl. No.: 10/100,597

(22) Filed: Mar. 18, 2002

(30) Foreign Application Priority Data
Mar. 21, 2001 (DE) 10113871.7

(51) Int. Cl. G01P 3/48; G01B 7/30

(52) U.S. Cl. 324/207.22; 324/207.25; 324/174

(57) ABSTRACT

Arrangement for determining a position, an angle and/or a rotational speed by means of a sensor (1), which has at least one sensor full bridge with two half bridges (3, 4), and by means of an encoder (2; 11) with laterally alternating magnet poles, a sinusoidal magnetic field running through the sensor (1) in the event of a relative movement between the sensor (1) and encoder (2; 11) such that the two half bridges (3, 4) of the sensor (1) each supply a sinusoidal sensor signal (V1, V2), and a sum signal (SUM) and a difference signal (DIFF) being obtained from these signals by means of forming sums and differences, respectively, which are evaluated in order to determine a position, an angle and/or a rotational speed.

The subject matter of the invention is an arrangement for determining a position, an angle, and/or a rotational speed. Provided in this case, on the one hand, is a sensor, and on the other, a magnetized encoder which has laterally alternating magnet poles in the relative direction of movement between the sensor and encoder. In the event of a relative movement between the sensor and encoder, the sensor supplies a sensor signal on the output side as a consequence of the magnetic field which flows through the sensor with varying magnitude.

Such an arrangement is disclosed in the German Laid-Open Application DE 19849613 A1. Provided there as sensor is a magnetoresistive angle sensor which can be moved relative to a magnetic body with magnetic strips. The arrangement has a magnetized encoder which has magnetic field lines running at a varying angle over its length. The angle of these magnetic field lines is measured, and the relative position between the sensor and the encoder is determined therefrom.

In this arrangement, the sensor is designed as an angle sensor since it must determine the angles of the magnetic field lines. The sensor is magnetoresistive and must therefore operate in the region of the magnetic field saturation, in order to determine only the direction of the magnetic field. Two sensor full bridges are provided as sensors. The arrangement delivers two signals phase shifted by 90°; however, there is the decisive qualification in this regard that these signals are displaced relative to one another by 90° only when the spacing of the two full bridges relative to one another on the one hand, and the variation in the angles of the magnetic field lines, over the length of the magnetic strip, on the other hand, satisfy specific geometric conditions. This constitutes a substantial limitation of the applicability, as does the fact that the magnetoresistive sensor must operate in the magnetic field saturation in order to be able to operate exclusively as an angle sensor.

It is an object of the invention to specify an arrangement of the type mentioned at the beginning which can be used universally and in which, therefore, stipulated geometric relationships between sensor and encoder need not be satisfied, and which need not operate in the region of the magnetic saturation.

This object is achieved as claimed in the invention by means of the following features of patent claim 1:

Arrangement for determining a position, an angle and/or a rotational speed by means of a sensor, which has at least one sensor full bridge, with two half bridges, and by means of an encoder with laterally alternating magnet poles, a sinusoidal magnetic field running through the sensor in the event of a relative movement between the sensor and encoder such that the two half bridges of the sensor each supply a sinusoidal sensor signal, and a sum signal and a difference signal being obtained from these signals by means of forming sums and differences, respectively, which are evaluated in order to determine a position, an angle and/or a rotational speed.

In the case of the arrangement as claimed in the invention, the sensor has at least one sensor full bridge with two half bridges. As a rule one sensor full bridge suffices in this case. Further provided is an encoder which has magnet poles alternating laterally in the relative direction of movement between sensor and encoder. Consequently, in the event of a relative movement between sensor and encoder a sinusoidal magnetic field flows through the sensor or the two sensor half bridges which the sensor has.

Consequently, the two half bridges of the sensor each supply a sinusoidal signal V1 and V2, respectively. A sum signal SUM, on the one hand, and a difference signal DIFF, on the other hand, are obtained from the signals by summing and subtraction, respectively. These two signals can be used in a way known per se to determine a position, an angle or else a rotational speed.

The formation of the sum signal SUM and the difference signal DIFF has the great advantage that these two signals always exhibit a phase shift of 90° relative to one another, and so these signals can be evaluated in the conventional way in order to determine position and angle. The substantial advantage as against the prior art also resides herein. In the case of the invention, there is no need to satisfy specific stipulated geometric relationships between the mutual spacing of the two sensor half bridges, on the one hand, and the spacing of the magnet poles on the encoder relative to one another, on the other hand.

Since, furthermore, the sensor does not function as an angle sensor, it can also be operated outside its saturation, that is to say with a smaller magnetic field.

Not only relative positions, but absolute positions can be determined with the aid of the arrangement as claimed in the invention. When use is made of one pair of magnet poles with the pole pair width X (encoder), the instantaneous absolute position can be detected via the encoder by means of a magnetoresistive sensor. In the case, for example, of a deactivation of the sensor system and a further activation, the information on the current position is retained and/or updated.

The previous state or position must be stored in order to measure a relative position.

Furthermore, for encoders with a plurality of pairs of magnet poles, an absolute position can be determined by, for example, activating a counter which detects the overshooting of the transitions of the magnet poles and increments or decrements accordingly depending on the direction of movement.

The sum signal and the difference signal or the values thereof, are evaluated when evaluating the position or the angle.

By contrast, in the case of determining a rotational speed, it suffices, as is provided in accordance with a configuration of the invention as claimed in claim 2, to undertake a determination of the zero crossings of one of the two or both signals.

Owing to an evaluation of the zero crossings both of the sum signal and of the difference signal, twice as many zero crossings arise for the determination of rotational speed than in the case of known solutions. This renders it possible, for example, to reduce the size of the encoder and halve the number of magnet poles, the number of the zero crossings per revolution of the encoder remaining constant by comparison with known solutions.

In the case of a further configuration of the invention as claimed in claim 3, the encoder is configured as a magnetized layer with alternating magnet poles. This magnetized layer can, on the one hand, be absolutely flat, for example, for determining a position between the layer and the sensor. However, it can also be bent in a circle and then be used, for example, for determining the position or rotational speed by means of the arrangement as claimed in the invention.

As described above, there is no need for special tuning between the spacing of the two sensor half bridges relative to one another on the one hand, and the spacing of two pairs of poles on the encoder, on the other hand. However, it is expedient as provided in accordance with a further refinement of the invention, as claimed in claim 4, for the spacing (d1) of the two sensor half bridges from one another to be selected to be smaller than the mutual spacing of two pairs of poles on the encoder.

If appropriate, there may be a wish to detect between the sensor and the encoder a change in position which is longer than the mutual spacing of two pairs of poles on the encoder. In accordance with a further refinement of the invention, in accordance with claim 5, there is provided for this purpose a counter for counting the number of zero crossings of the sum signal SUM and/or the difference signal DIFF. Consequently, in addition to determining the position or the angle with the aid of the current value of the sum signal SUM and the difference signal DIFF it is possible, furthermore, to determine the coarse position by counting the zero crossings.

As already mentioned above, methods are known for determining the relative position between sensor and encoder by means of trigonometric formulas from sinusoidal and cosinusoidal signals.

An Arctan function can advantageously be used for this purpose, as in accordance with a further refinement of the invention as claimed in claim 6.

The formulas specified in this claim make plain, inter alia, that the two signals SUM and DIFF are phase shifted exactly by 90° relative to one another. This means that, for example, whenever the DIFF signal has a zero crossing, an extreme value occurs in the SUM signal, and vice versa. Because of this mutual relationship between the two signals, the two signals can be evaluated directly by means of such an ARCTAN function, and an angle determination can therefore be undertaken directly. If, if appropriate, a position is to be determined, a position is determined from the angle by means of a linear characteristic.

An exemplary embodiment of the invention is explained in more detail below with the aid of the drawing, in which:

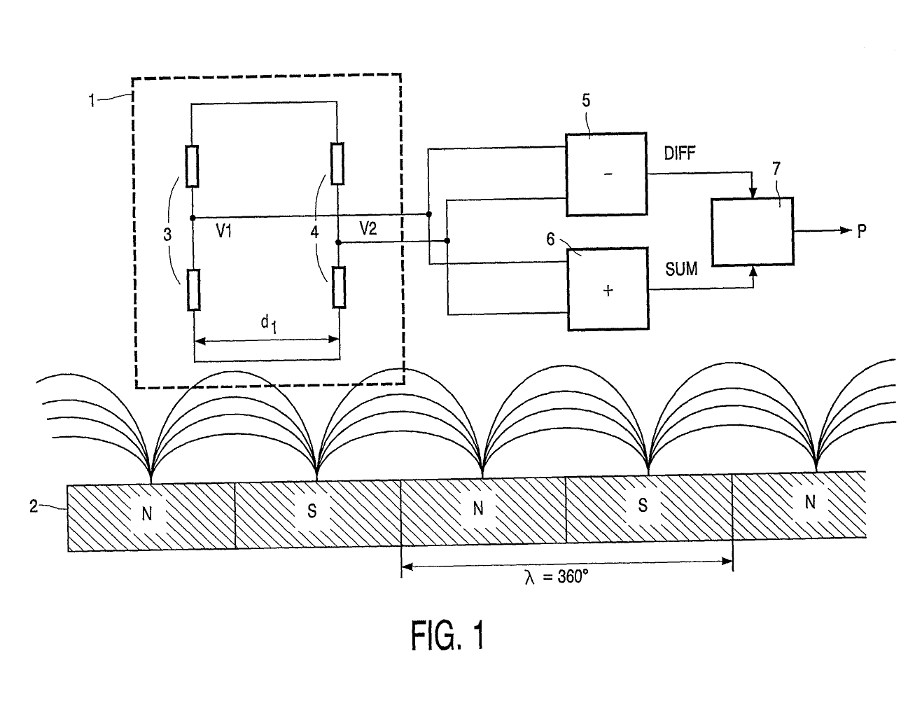

FIG. 1 shows a first form of the embodiment of the arrangement as claimed in the invention for determining a position,

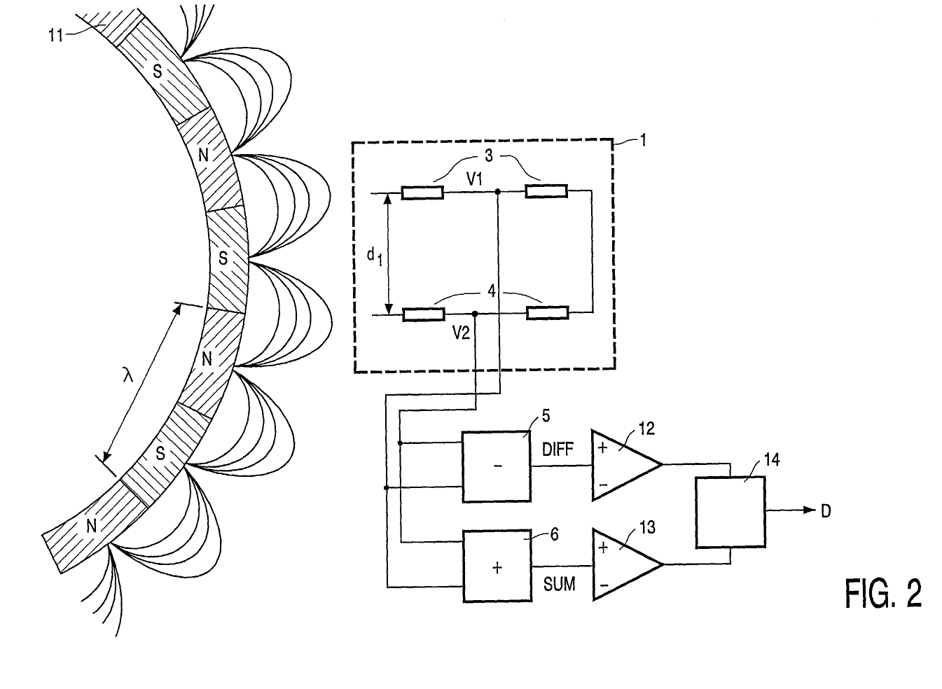

FIG. 2 shows a second embodiment of the arrangement as claimed in the invention for determining a rotational speed,

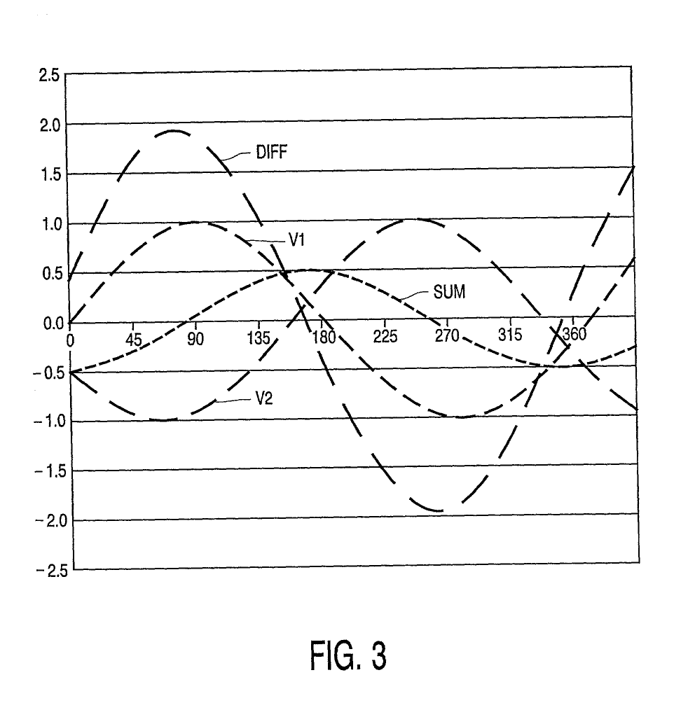

FIG. 3 shows the output signals of the two sensor half bridges, and the sum and difference signals of the arrangements, in accordance with FIG. 1 or FIG. 2, and

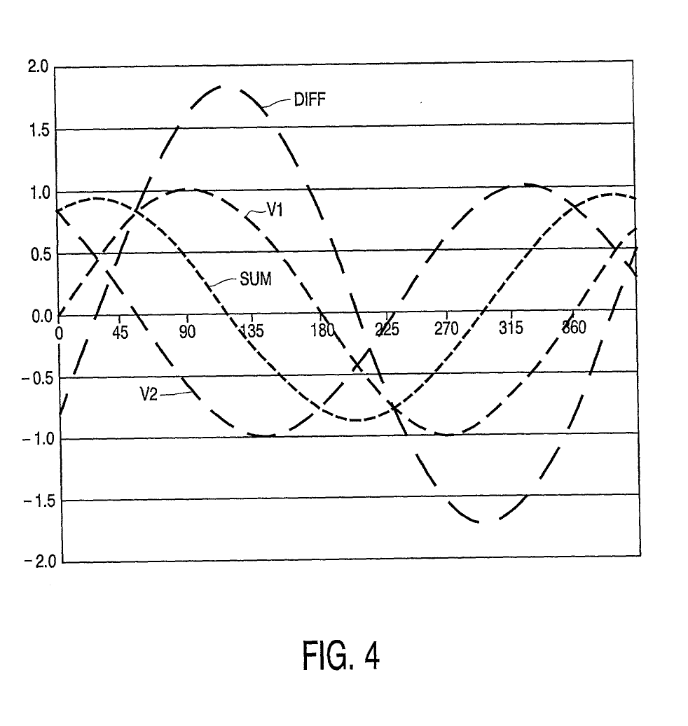

FIG. 4 shows an illustration corresponding to FIG. 3, with different geometric relationships of the sensor half bridges and/or the width of the pair of poles and thus a different phase relationship between the signals V1 and V2 of the sensor half bridges.

Illustrated in FIG. 1 is a diagrammatic depiction and a block diagram of an arrangement as claimed in the invention in a first embodiment which is suitable for determining a position, and with a slight modification, an angle.

A relative position between a sensor 1 and an encoder 2 is to be determined by means of the arrangement.

The illustration in accordance with FIG. 1 shows that the encoder 2 is magnetized in a changing fashion in the lateral direction. Following one another in this direction in an alternating fashion are pairs of poles which in each case have the length of an angle lambda=360°. The value of lambda (λ) is used further below for the purpose of calculating the position or the angle.

The sensor 1 and the encoder 2 can be displaced relative to one another in the longitudinal direction of the encoder 2. Consequently, the magnetic field lines illustrated schematically in FIG. 1 will flow through the sensor 1. In the event of a movement of the described type, two sensor half bridges 3 and 4 of the sensor 1 detect the magnetic field of the encoder 2, and so in the event of a movement between the sensor 1 and encoder 2 the sensor 1 supplies sinusoidal signals.

Consequently, the two sensor half bridges 3 and 4, which each have two sensor elements, supply sinusoidal output signals V1 and V2, respectively, which are tapped in each case between the two sensor elements of the sensor half bridges 3 and 4.

Because of the above-described temporal response of the magnetic field lines in the two sensor half bridges 3 and 4, the signals V1 and V2 are also sinusoidal.

The two sensor half bridges 3 and 4 have a spacing of d₁ from one another.

The two sensor signals V1 and V2 exhibit a specific phase shift relative to one another as a function of the value of d₁ and the value of lambda. However, in order to evaluate these signals by means of trigonometric functions it is necessary for the sensor signals to exhibit a prescribed angle relative to one another, specifically 90°. This means, in turn, that either the magnetic array on the encoder 2, that is to say the value lambda, or the spacing of the two half bridges 3 and 4 from one another, that is to say the value d₁, must have specific values. Applications intended therefore [sic] for example for motor vehicle sensors for antilock systems, such tuning is impossible or not desired, the invention pursues a different path 3 and does not evaluate the sensor signals V1 and V2 directly.

The arrangement as claimed in the invention therefore provides a subtractor 5 and an adder 6 which are respectively fed two sensor signals V1 and V2. Subtractor 5 forms a difference signal DIFF from the signals; the adder 6 forms a sum signal SUM from you [sic].

These two signals have a mutual phase offset of exactly 90°, and can therefore be evaluated by means of trigonometric functions. This evaluation is undertaken in an evaluation stage 7 which supplies on the output side a signal P which represents the value of the relative position between the sensor 1 and encoder 2.

An ARCTAN calculation can advantageously be carried out to calculate a value for a specific position by means of the evaluation stage 7. In this case, there is produced from the signals SUM and DIFF a linear characteristic that can be used to determine the instantaneous angle a directly.

The value which is yielded on the basis of ARCTAN calculation (here the angle α) must be converted appropriately into a length for the purpose of determining a position. It is likewise to be borne in mind that the amplitudes of the signals SUM and DIFF must be corrected.

The calculation of the angle a can be undertaken using the following equations:

The equations

$$DIFF \text{:} = V 1 - V 2 = 2 * V 0 * cos ( \frac{phi}{2} ) * sin ( ω t ) \qquad [ 1 ]$$

$$SUM \text{:} = V 1 + V 2 = 2 * V 0 * sin ( \frac{phi}{2} ) * sin ( ω t - {90}^{∘} ) \qquad [ 2 ]$$

yield:

$$tan ( α ) = \frac{DIFF}{SUM} = \frac{2 * V 0 * cos ( \frac{phi}{2} ) * sin ( ω t )}{2 * V 0 * sin ( \frac{phi}{2} ) * sin ( ω t - {90}^{∘} )}$$

$$= \frac{cos ( \frac{phi}{2} ) * sin ( ω t )}{sin ( \frac{phi}{2} ) * - cos ( ω t )} = \frac{- tan ( ω t )}{tan ( \frac{phi}{2} )} where tan ( \frac{phi}{2} ) = const . = c \qquad [ 3 ]$$

$$α = arctan ( \frac{- tan ( ω t )}{c} ) where c = tan ( \frac{phi}{2} ) \qquad [ 4 ]$$

in which case,

phi: is the phase offset between the signals V1 and V2,

α: is the calculated angle,

V0: is the maximum amplitude of the signals V1 and V2,

V1: is the output signal of the first half bridge,

V2: is the output signal of the second half bridge and

ωt: is the circular velocity of the signals V1 and V2.

These equations show, inter alia, the [sic] for example, the sign of the difference signal DIFF remains unchanged in the event of a change in sign of the phase difference phi. By contrast, there is a change in the sign of the sum signal SUM. Furthermore, these formulas show that the signals SUM and DIFF undergo a mutual phase shift of exactly 90°. It is only in this way that a relatively simple evaluation of the signals by means of the above-named trigonometric functions is possible.

It may be desirable on occasion for the relative travel path between the sensor 1 and encoder 2 in the illustration in accordance with FIG. 1 to be greater than lambda (λ). In this case, it is advantageous to provide in the evaluation stage 7 a counter by means of which it can be determined at which coarse position the two are located relative to one another. The fine position is then determined with the aid of the trigonometric function.

Given an appropriate geometric configuration of the sensor 2, for example as a ring, the arrangement in accordance with FIG. 1 can also be used in a virtually unchanged way, for the purpose of determining rotational speed. In this case, it is possible to evaluate the angle alpha directly, and there is then no need to convert the angle alpha to a linear travel path by means of a linear characteristic.

FIG. 2 illustrates a second embodiment of the arrangement as claimed in the invention in which an encoder 11 is provided which corresponds in principle to the encoder 2 in accordance with FIG. 1, but is of annular design.

The arrangement in accordance with FIG. 2 is slightly expanded, in order to permit measurement of rotational speed.

Apart from the encoder 11, the remaining arrangement is largely identical to that in accordance with FIG. 1; in particular the sensor 1 with its two sensor half bridges 3 and 4 is of identical design to the arrangement in accordance with FIG. 1. Moreover, a subtractor 5 and an adder 6, which supply the sum signal SUM and the difference signal DIFF, are provided again in this arrangement.

In the exemplary embodiment in accordance with FIG. 2, these two signals are evaluated in such a way that they are firstly fed to comparators 12 and 13 which use them to supply simple square-wave signals. These square-wave signals are evaluated by means of a stage 14 for the purpose of determining rotational speed. A frequency which corresponds to the frequency of the zero crossings of the sum signal SUM and difference signal DIFF can be determined directly from the square-wave signals which are supplied by comparators 12 and 13. The stage 14 for determining rotational speed counts these zero crossings per time unit and determines directly therefrom a rotational speed whose value is output as signal D.

FIGS. 3 and 4 show signal profiles against the angle λ such as can occur, for example, in the arrangement in accordance with FIG. 1 or 2 for the purpose of determining the position or angle. Here, a value of λ=360 degrees corresponds to a relative movement between the sensor 1 and encoder 2 or 11 by the length of a pair of poles of the magnetization of the encoder 2 or 11.

Thus, FIG. 3 shows the output signal V1 of the first sensor half bridge 3 of the arrangement in accordance with FIG. 1, as well as the output signal V2 of the second sensor half bridge 4. The illustration shows that these do not exhibit a mutual phase shift of 90° but a smaller one of approximately 26°. This occurs whenever the mutual spacing D1 of the two sensor half bridges 3 and 4, and the value lambda of the magnetization of the encoder do not exhibit specific relationships.

Since the arrangement as claimed in the invention is aimed specifically at dispensing with this tuning, the sum signal SUM and the difference signal DIFF likewise plotted in the figure are generated. The figure shows that these two signals have a mutual phase shift of 90°, and are therefore open directly to trigonometric evaluation.

An illustration corresponding to FIG. 3 is to be found in FIG. 4, but because of different geometric relationships, here the value D1 or lambda, in a phase offset between the signals V1, V2, is approximately 54°. Here, as well, however, the phase offset between the sum signal SUM and the difference signal DIFF is once again 90°.

The illustrations in accordance with FIGS. 3 and 4 therefore show that exact mutual tuning of the values D1 and lambda is not necessary; rather, it is possible nevertheless to make an evaluation in accordance with the arrangement as claimed in the invention by forming the sum signal SUM and the difference signal DIFF, which always have a mutual phase shift of 90°.

FIGS. 3 and 4 show, moreover, that in the case of determining rotational speed by means of the arrangement as claimed in FIG. 2, when evaluating the zero crossings both of the sum signal SUM and of the difference signal DIFF, twice as many zero crossings occur per revolution of the encoder 11 for the determination of rotational speed as in the case of known solutions. This renders it possible, for example to scale down the encoder 11 and halve the number of magnet poles, the number of zero crossings per revolution of the encoder remaining the same compared with known solutions.

1. An arrangement for determining a position, an angle and/or a rotational speed by means of a sensor (1), which has at least one sensor full bridge, with two half bridges (3, 4), and by means of an encoder (2; 11) with laterally alternating magnet poles, a sinusoidal magnetic field running through the sensor (1) in the event of a relative movement between the sensor (1) and encoder (2; 11) such that the two half bridges (3, 4) of the sensor (1) each supply a sinusoidal sensor signal (V1, V2), and a sum signal (SUM) and a difference signal (DIFF) being obtained from these signals by means of forming sums and differences, respectively, which are evaluated in order to determine a position, an angle and/or a rotational speed.

2. The arrangement as claimed in claim 1, wherein a determination of rotational speed is undertaken using means (14) for determining the zero crossings of the sum signal SUM and/or the difference signal DIFF.

3. The arrangement as claimed in claim 1, wherein a magnetized layer with alternating magnet poles is used as encoder (2; 11).

4. The arrangement as claimed in claim 1, wherein the spacing (d₁) of the two sensor half bridges (3, 4) from one another is smaller than the length (λ) of a pair of poles of the encoder (2; 11).

5. The arrangement as claimed in claim 1, wherein a counter is provided for counting preferably the zero crossings of the sum signal SUM and/or the difference signal DIFF, such that it is possible to determine the position via a relative movement between sensor and encoder, which is longer than the length (λ) of a pair of poles of the encoder.

6. The arrangement as claimed in claim 1, wherein in order to calculate a value of a position or an angle by means of an ARCTAN calculation, the arrangement generates a linear characteristic on which the value is determined, the ARCTAN calculation being performed according to the following equations:
$$DIFF \text{:} = V 1 - V 2 = 2 * V 0 * cos ( \frac{phi}{2} ) * sin ( ω t ) \qquad [ 1 ]$$
$$SUM \text{:} = V 1 + V 2 = 2 * V 0 * sin ( \frac{phi}{2} ) * sin ( ω t - {90}^{∘} ) \qquad [ 2 ]$$
$$\begin{matrix}tan ( α ) = \frac{DIFF}{SUM} = \frac{2 * V 0 * cos ( \frac{phi}{2} ) * sin ( ω t )}{2 * V 0 * sin ( \frac{phi}{2} ) * sin ( ω t - {90}^{∘} )} \\ = \frac{cos ( \frac{phi}{2} ) * sin ( ω t )}{sin ( \frac{phi}{2} ) * - cos ( ω t )} = \frac{- tan ( ω t )}{tan ( \frac{phi}{2} )} where tan ( \frac{phi}{2} ) = const . = c\end{matrix} \qquad [ 3 ]$$
$$α = arctan ( \frac{- tan ( ω t )}{c} ) where c = tan ( \frac{phi}{2} ) \qquad [ 4 ]$$
where:
α: is the calculated angle,
V0: is the maximum amplitude of the signals V1 and V2,
V1: is the output signal of the first half bridge,
V2: is the output signal of the second half bridge,
phi: is the phase offset between the signals V1 and V2, and
ωt: is the circular velocity of the signals V1 and V2.
